(19) United States
(12) Patent Application Publication
(10) Pub. No.: US 2024/0232637 A9
(43) Pub. Date: Jul. 11, 2024

(54) Method for Training Large Language Models to Perform Query Intent Classification

(71) Applicant: Google LLC, Mountain View, CA (US)

(72) Inventors: Krishna Pragash Srinivasan, Union City, CA (US); Michael Bendersky, Cupertino, CA (US); Anupam Samanta, Mountain View, CA (US); Lingrui Liao, Foster City, CA (US); Luca Bertelli, Redwood City, CA (US); Ming-Wei Chang, Redmond, WA (US); Iftekhar Naim, San Jose, CA (US); Siddhartha Brahma, San Jose, CA (US); Siamak Shakeri, New York, NY (US); Hongkun Yu, Redwood City, CA (US); John Nham, Fremont, CA (US); Karthik Raman, Sunnyvale, CA (US); Raphael Dominik Hoffmann, Los Altos, CA (US)

(21) Appl. No.: 18/491,877

(22) Filed: Oct. 23, 2023

Related U.S. Application Data
(60) Provisional application No. 63/418,151, filed on Oct. 21, 2022.

(51) Int. Cl. G06N 3/0895; G06F 16/903; G06F 16/93; G06N 3/0455

(52) U.S. Cl. CPC G06N 3/0895; G06F 16/90335; G06F 16/93; G06N 3/0455

(57) ABSTRACT

Provided are computing systems, methods, and platforms that train query processing models, such as large language models, to perform query intent classification tasks by using retrieval augmentation and multi-stage distillation. Unlabeled training examples of queries may be obtained, and a set of the training examples may be augmented with additional feature annotations to generate augmented training examples. A first query processing model may annotate the retrieval augmented queries to generate inferred labels for the augmented training examples. A second query processing model may be trained on the inferred labels, distilling the query processing model that was trained with retrieval augmentation into a non-retrieval augmented query processing model. The second query processing model may annotate the entire set of unlabeled training examples. Another stage of distillation may train a third query processing model using the entire set of unlabeled training examples without retrieval augmentation.

### RELATED APPLICATIONS

This application claims priority to and the benefit of U.S. Provisional Patent Application No. 63/418,151, which is hereby incorporated by reference in its entirety.

### FIELD

The present disclosure relates generally to machine learning. More particularly, the present disclosure relates to computing systems, methods, and platforms that train large language models to perform query intent classification tasks by using retrieval augmentation and multi-stage distillation.

### BACKGROUND

Machine learning is a field of computer science that includes the building and training (e.g., via application of one or more learning algorithms) of analytical models that are capable of making useful predictions or inferences on the basis of input data. Machine learning is based on the idea that systems can learn from data, identify patterns, and make decisions with minimal human intervention.

Large language models are machine learning models that are trained on large amounts of data to perform language understanding tasks. For example, large language models can be used to perform the task of query intent classification, where the predicted query intent from a user's query input into a search engine can change the behavior of the entire search engine.

However, search queries pose a unique challenge for large language models because they are short in length and lack nuance or context, which requires more memorization and knowledge than other natural language processing tasks.

Retrieval augmentation of queries can provide additional context to the large language model and enable an improved query understanding. Retrieval augmentation improves accuracy but increases latency of large language models because of the longer inputs that result from it, which in turn decreases the distillation efficacy. The result is a choice between a more effective language model with a smaller distillation set or a lower performing language model with a larger distillation set; however, a large distillation set is required to train an effective language model and benefit from retrieval augmentation. Therefore, improved techniques are desired to enhance the performance of large language models on language and query understanding tasks.

### SUMMARY

Aspects and advantages of embodiments of the present disclosure will be set forth in part in the following description, or can be learned from the description, or can be learned through practice of the embodiments.

According to one example embodiment of the present disclosure, a computing system for efficiently training query processing models can include one or more processors. The computing system can further include one or more non-transitory computer-readable media that collectively store instructions that, when executed by the one or more processors, cause the computing system to perform operations. The operations can include obtaining a first plurality of unlabeled training examples, the first plurality of unlabeled training examples respectively comprising a first plurality of queries. The operations can further include augmenting the first plurality of queries with one or more additional feature annotations to generate a first plurality of augmented training examples. The operations can further include processing the first plurality of augmented training examples with a first query processing model to respectively generate a first plurality of inferred labels for the first plurality of augmented training examples. The operations can further include training a second query processing model to predict the first plurality of inferred labels for the first plurality of augmented training examples. The operations can further include obtaining a second plurality of unlabeled training examples, the second plurality of unlabeled training examples respectively comprising a second plurality of queries, each of the second plurality of unlabeled training examples comprising a smaller number of features than the first plurality of augmented training examples. The operations can further include processing the second plurality of unlabeled training examples with the second query processing model to respectively generate a second plurality of inferred labels for the second plurality of unlabeled training examples. The operations can further include training a third query processing model to predict the second plurality of inferred labels for the second plurality of unlabeled training examples.

According to another example embodiment of the present disclosure, a computer-implemented method for efficiently training query processing models can be performed by one or more computing devices and can include obtaining a first plurality of unlabeled training examples, the first plurality of unlabeled training examples respectively comprising a first plurality of queries. The computer-implemented method can further include augmenting the first plurality of queries with one or more additional feature annotations to generate a first plurality of augmented training examples. The computer-implemented method can further include processing the first plurality of augmented training examples with a first query processing model to respectively generate a first plurality of inferred labels for the first plurality of augmented training examples. The computer-implemented method can further include training a second query processing model to predict the first plurality of inferred labels for the first plurality of augmented training examples. The computer-implemented method can further include obtaining a second plurality of unlabeled training examples, the second plurality of unlabeled training examples respectively comprising a second plurality of queries, each of the second plurality of unlabeled training examples comprising a smaller number of features than the first plurality of augmented training examples. The computer-implemented method can further include processing the second plurality of unlabeled training examples with the second query processing model to respectively generate a second plurality of inferred labels for the second plurality of unlabeled training examples. The computer-implemented method can further include training a third query processing model to predict the second plurality of inferred labels for the second plurality of unlabeled training examples.

According to another example embodiment of the present disclosure, one or more non-transitory computer-readable media can collectively store a third query processing model that has been trained by performance of training operations. The training operations can include obtaining a first plurality of unlabeled training examples, the first plurality of unlabeled training examples respectively comprising a first plurality of queries. The training operations can further include augmenting the first plurality of queries with one or more additional feature annotations to generate a first plurality of augmented training examples. The training operations can further include processing the first plurality of augmented training examples with a first query processing model to respectively generate a first plurality of inferred labels for the first plurality of augmented training examples. The training operations can further include training a second query processing model to predict the first plurality of inferred labels for the first plurality of augmented training examples. The training operations can further include obtaining a second plurality of unlabeled training examples, the second plurality of unlabeled training examples respectively comprising a second plurality of queries, each of the second plurality of unlabeled training examples comprising a smaller number of features than the first plurality of augmented training examples. The training operations can further include processing the second plurality of unlabeled training examples with the second query processing model to respectively generate a second plurality of inferred labels for the second plurality of unlabeled training examples. The training operations can further include training the third query processing model to predict the second plurality of inferred labels for the second plurality of unlabeled training examples.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of implementations directed to one of ordinary skill in the art is set forth in the specification, which makes reference to the appended figures, in which:

FIG. 1A depicts a block diagram of an example computing system that performs training query processing models according to example embodiments of the present disclosure.

FIG. 1B depicts a block diagram of an example computing device that performs training query processing models according to example embodiments of the present disclosure.

FIG. 1C depicts a block diagram of an example computing device that performs training query processing models according to example embodiments of the present disclosure.

FIG. 2 depicts a block diagram of an example of training query processing models according to example implementations of the present disclosure.

FIG. 3 depicts a flow chart diagram of an example method to perform training query processing models according to example embodiments of the present disclosure.

Reference numerals that are repeated across plural figures are intended to identify the same features in various implementations.

### DETAILED DESCRIPTION

### Overview

Generally, the present disclosure is directed to computing systems, methods, and platforms that train query processing models, such as large language models or other sequence processing models such as vision-language models, to perform query intent classification tasks by using retrieval augmentation and multi-stage distillation. Retrieval augmentation of the queries improves large language model performance by providing models with the additional context necessary to enable an improved understanding of the search query. In particular, one example computing system can use retrieval augmentation by concatenating a search query with the title and URL of the retrieved document.

The computing system can train a query processing model (e.g., a large language model, vision-language model, other sequence processing model, etc.) with retrieval augmentation of the queries. The retrieval augmentation results in longer inputs, which decreases the distillation efficacy, thus a multi-stage distillation process can be used by the proposed system to distill the trained model and improve the performance of query intent prediction. Therefore, by using the multi-stage distillation process, the benefits of retrieval augmentation can be realized without suffering the increased compute time that is generally associated with retrieval augmentation.

In one example, the multi-stage process can include two stages. During the first stage of distillation, the proposed system can distill the query processing model that was trained with retrieval augmentation into a non-retrieval augmented query processing model (e.g., a non-retrieval augmented large language model) by using a small set of training data. In this stage, a small subset of unlabeled data can be used to train a second query processing model (e.g., a second large language model). Training a large language model with a small subset of unlabeled data performs better than training a large language model without retrieval augmentation directly on human data and results in more efficient distillation of the model. Thus, a non-retrieval augmented query processing model can be trained to benefit from the gains of retrieval augmentation, without the increased cost of retrieval augmentation, by using this approach. The resulting query processing model can then be used in the second stage of distillation.

During the second stage of distillation, the proposed system can distill the second query processing model into a smaller query processing model (e.g., a smaller large language model) using a large set of training data without retrieval augmentation. The full unlabeled data set can be used in this stage. The second query processing model can annotate the entire unlabeled data set, rather than a small subset of the unlabeled data set, which can be used to train a third query processing model (e.g., a third large language model). The resulting query processing model can then be used in practical applications, such as for online use.

In another aspect, the computing system can use the proposed retrieval augmentation and multi-stage distillation process to perform any query understanding task, including query intent classification. Query intent classification, for example, needs language models that are fast (i.e., low latency) and high efficacy, thus the proposed system can improve the query intent task. Other query understanding tasks can benefit from the proposed system because it enables the use of retrieval augmentation to improve query understanding while reducing the computing resources for retrieval augmentation, resulting in production language models that are real-world capable and that can be used in various applications.

Another aspect of the present disclosure is directed to identifying queries with a specific intent, for example in the context of e-commerce. In particular, human-labeled data can be accompanied by a large unlabeled data set for the proposed system to use for knowledge distillation.

In another aspect, the proposed system can use a data set that is human-labeled and contains queries labeled with one or more intent classes from among a set of multiple intent classes.

The systems and methods of the present disclosure provide a number of technical effects and benefits. As one example, various computing systems and applications would benefit from an improvement in the performance of large language models on language and query understanding tasks. The proposed system provides value because the increase in the complexity of large language model inference that normally occurs when using retrieval augmentation is reduced, with no loss in performance and a decrease in computing time. Without the setbacks of retrieval augmentation, large language models trained with the proposed system can retain the performance gains of retrieval augmentation on query understanding tasks, making these large language models practical for online use or other applications. Thus, the proposed systems improve the functionality of a computer for various tasks.

As another example technical effect and benefit, the computing resources used for query understanding tasks are reduced when using retrieval augmentation and multi-stage distillation. Retrieval augmentation of a data set uses many computing resources. For example, using retrieval augmentation to improve query understanding on an entire data set with millions of examples uses many computing resources. However, using retrieval augmentation on a subset of the data set (i.e., a smaller data set) uses less computing resources. Thus, training a large language model with a retrieval augmented subset of the data set saves considerable computing resources. Furthermore, a large language model trained with the retrieval augmented subset of the data set can then be distilled into a smaller large language model using the entire training data without retrieval augmentation. Therefore, a resulting large language model can be obtained with the benefit of retrieval augmentation and without the increased computing resources of using retrieval augmentation on the entire data set.

With reference now to the Figures, example implementations of the present disclosure will be discussed in greater detail.

### Example Devices and Systems

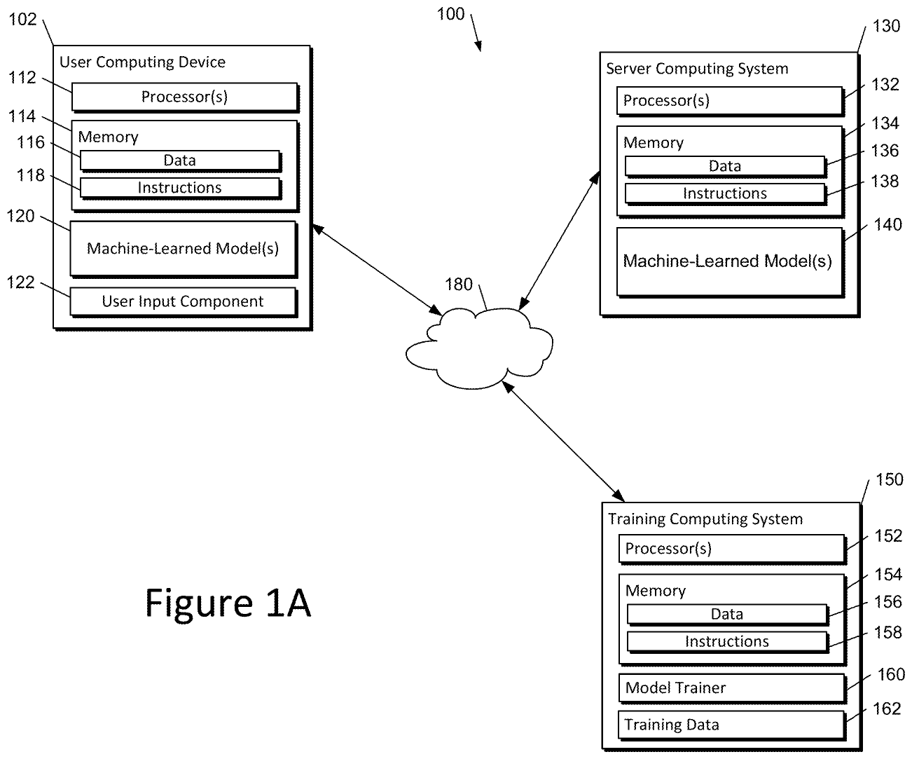

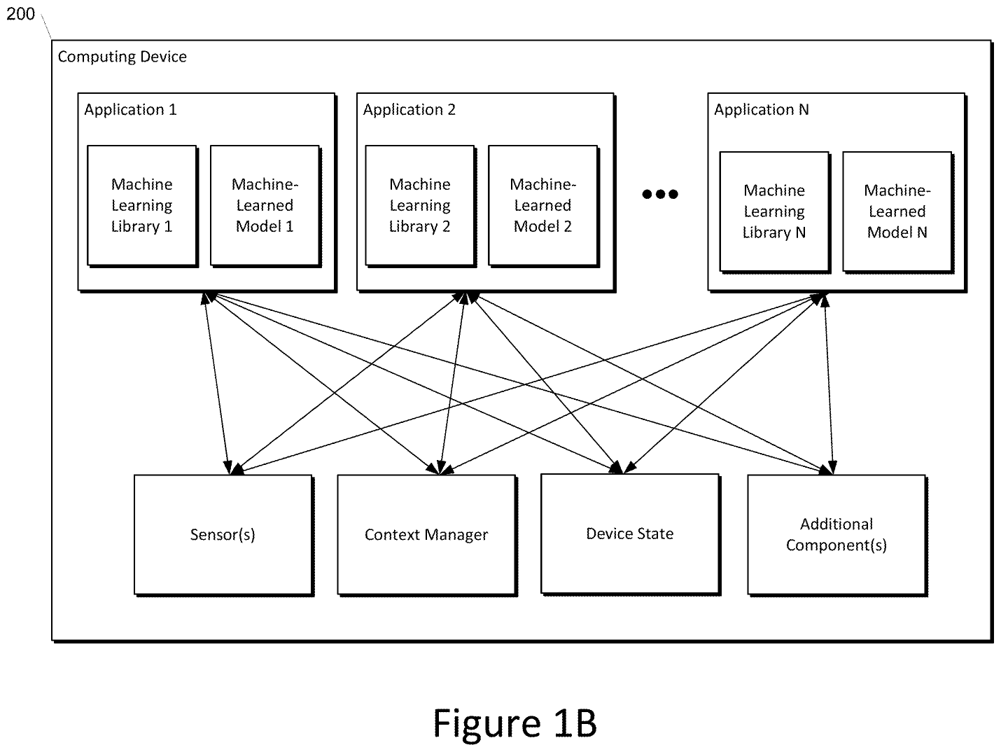

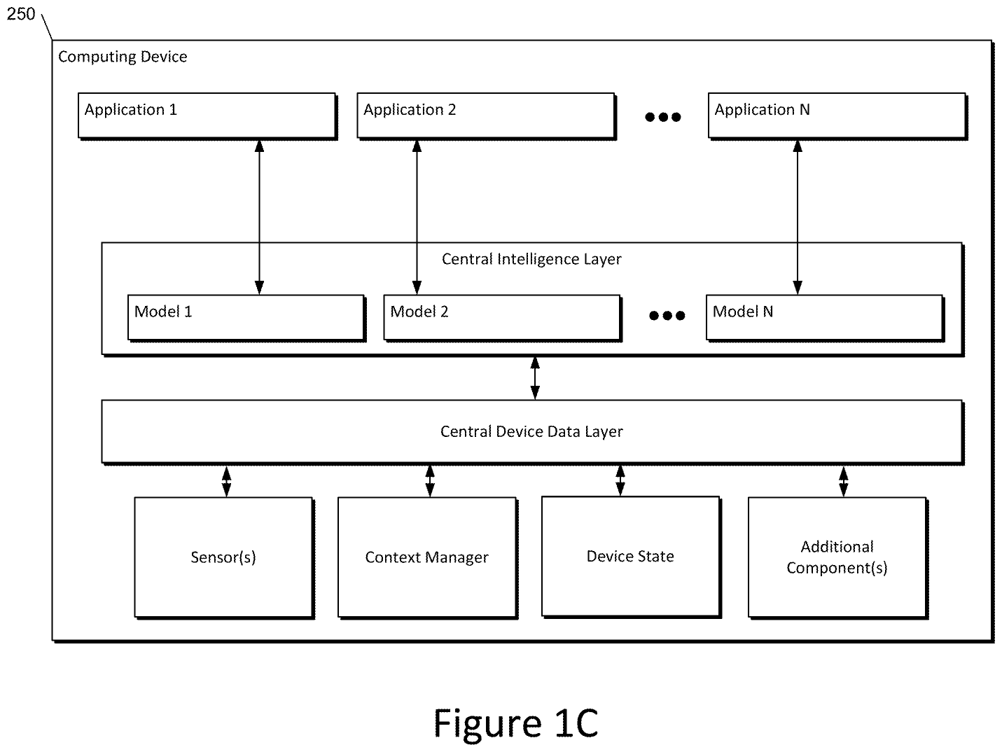

FIG. 1A depicts a block diagram of an example computing system 100 that performs training query processing models according to example embodiments of the present disclosure. The computing system 100 includes a user computing device 102, a server computing system 130, and a training computing system 150 that are communicatively coupled over a network 180. Other computing systems can be used as well. For example, in some implementations, the user computing device 102 can include the model trainer 160 and the training dataset 162. In such implementations, the machine-learned models 120 and 140 can be both trained and used locally at the user computing device 102. In some of such implementations, the user computing device 102 can implement the model trainer 160 to personalize the machine-learned models 120 based on user-specific data.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

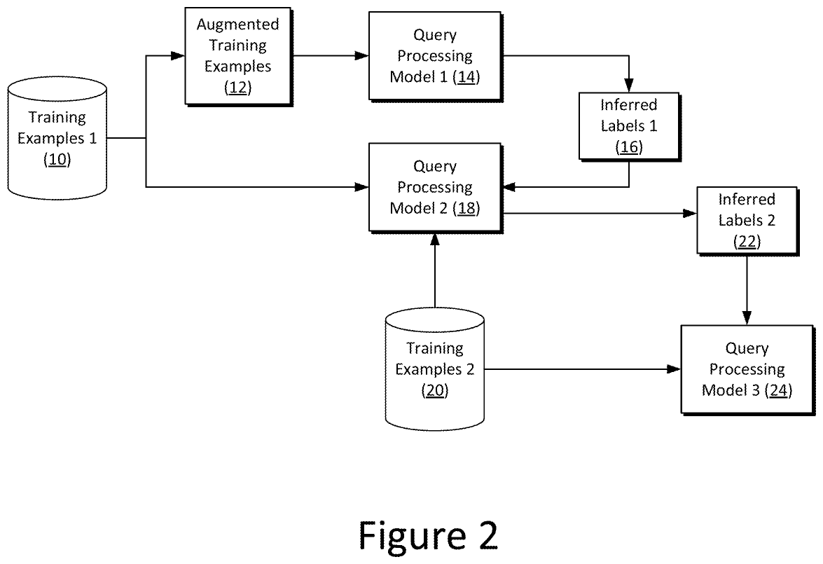

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIG. 2.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel retrieval augmentation and multi-stage distillation across multiple instances).

Additionally, or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 130 as a portion of a web service. Thus, one or more machine-learned models 120 can be stored and implemented at the user computing device 102 and/or one or more machine-learned models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example machine-learned models 140 are discussed with reference to FIG. 2.

The user computing device 102 and/or the server computing system 130 can train the machine-learned models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, queries of search terms and other query input such as queries input into a search engine.

In some implementations, if the user has provided consent, the training examples can be provided by the user computing device 102. Thus, in such implementations, the machine-learned model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1B depicts a block diagram of an example computing device 200 that performs training query processing models according to example embodiments of the present disclosure. The computing device 200 can be a user computing device or a server computing device.

The computing device 200 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 250 that performs training query processing models according to example embodiments of the present disclosure. The computing device 250 can be a user computing device or a server computing device.

The computing device 250 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 250.

The central intelligence layer can communicate with a central device data layer. The central device data layer can be a centralized repository of data for the computing device 250. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

### Example Multi-Stage Distillation

FIG. 2 depicts a block diagram of an example of multi-stage distillation for training query processing models according to example embodiments of the present disclosure. In some implementations, the example multi-stage distillation illustrated in FIG. 2 can receive a first plurality of training examples 10. The training examples 10 may be an unlabeled set of training examples. In at least one implementation, the unlabeled training examples in training examples 10 may comprise a plurality of search queries. In one or more implementations, training examples 10 may be used to train query processing models (e.g., large language models) on query intent classification tasks.

The queries in training examples 10 may be augmented with one or more additional feature annotations to generate augmented training examples 12. For example, augmented training examples 12 may include the queries in training examples 10 augmented with the titles of documents retrieved for the queries or the URLs of documents retrieved for the queries. For instance, the titles of the documents or the URLs of the documents can be concatenated with a query, and the query can be used as an input to a query processing model. For example, for a query of “ua 1234,” it may not be immediately apparent what they query is asking, however, the retrieved documents for the query can provide additional context that allows a model to determine that the query is seeking information about a United Airlines flight.

A first query processing model 14 (e.g., a first large language model) may be used to annotate a data set comprising the augmented training examples 12. For instance, the first query processing model 14 may process the augmented training examples 12 to generate inferred labels 16 for the augmented training examples 12. Thus, the first query processing model 14 may infer labels for the unlabeled training examples 10 that have been augmented in augmented training examples 12 to generate inferred labels 16 for another model to train on.

The first query processing model 14 may be distilled into a second query processing model 18 (e.g., a second large language model). For instance, the second query processing model 18 may be trained to predict the inferred labels 16 for the augmented training examples 12. The second query processing model 18 may be trained on the first set of training examples 10 and the inferred labels 16 so the second query processing model 18 can learn to predict the inferred labels 16. Thus, the second query processing model 18 can be trained to benefit from the gains of retrieval augmentation. In order to train the second query processing model 18, the training examples 10 may not be augmented.

A second set of training examples 20 may be obtained for use in another stage of distillation. The second set of training examples 20 may be an unlabeled set of training examples. In at least one implementation, the unlabeled training examples in training examples 20 may comprise a plurality of search queries. In at least one implementation, the second set of training examples 20 may be larger than the first set of training examples 10. The training examples 20 may not be augmented with one or more additional feature annotations. Thus, training examples 20 may contain a smaller number of feature annotations than the augmented training examples 12.

The second query processing model 18 may be used to annotate a data set comprising the second set of training examples 20. For instance, the second query processing model 18 may process the training examples 20 to generate a second set of inferred labels 22 for the training examples 20. Thus, the second query processing model 18 may infer labels for the unlabeled training examples 20 that have not been augmented to generate inferred labels 22 for another model to train on. In at least one implementation, the second set of training examples 20 may be larger than the first set of training examples 10. Thus, the second query processing model 18 may annotate an entire unlabeled data set.

The second query processing model 18 may be distilled into a third query processing model 24 (e.g., a third large language model). For instance, the third query processing model 24 may be trained to predict the second set of inferred labels 22 for the second set of training examples 20. The third query processing model 24 may be trained on the second set of training examples 20 and the second set of inferred labels 22 so the third query processing model 24 can learn to predict the inferred labels 22.

In at least one implementation, the second set of training examples 20 may be larger than the first set of training examples 10. Thus, the second query processing model 18 can be distilled into the third query processing model 24 using a large data set. The second query processing model 18, distilled from the retrieval-augmented first query processing model 14, generated the second set of inferred labels 22 for training the third query processing model 24. Thus, the third query processing model 24 can be trained to benefit from the gains of retrieval augmentation while being smaller than the first query processing model 14 and the second query processing model 18 and using a larger set of training examples.

### Example Methods

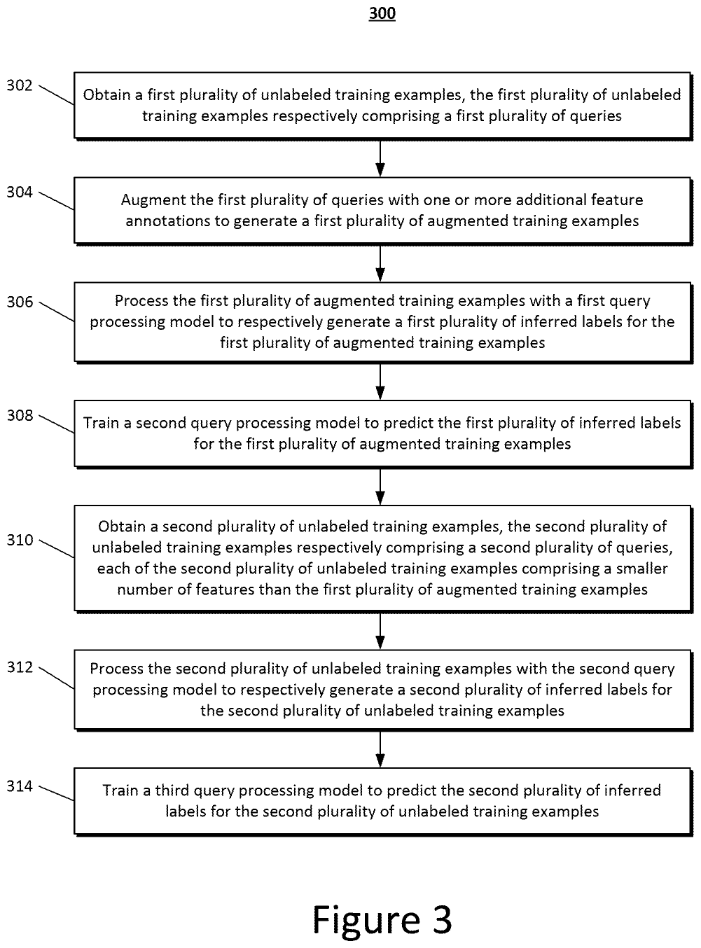

FIG. 3 depicts a flow chart diagram of an example method to perform training query processing models according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system obtains a first plurality of unlabeled training examples, the first plurality of unlabeled training examples respectively comprising a first plurality of queries. In some implementations, the first plurality of queries comprises queries of technical terminologies. In some examples, the computing system obtains a first plurality of labeled training examples, the first plurality of labeled training examples respectively comprising a first plurality of queries. The first plurality of labeled training examples are labeled with a query intent class in some examples.

At 304, the computing system augments the first plurality of queries with one or more additional feature annotations to generate a first plurality of augmented training examples. In some implementations, the one or more additional feature annotations comprises URLs of documents retrieved for the first plurality of queries. In another example, the one or more additional feature annotations comprises titles of documents retrieved for the first plurality of queries.

At 306, the computing system processes the first plurality of augmented training examples with a first query processing model to respectively generate a first plurality of inferred labels for the first plurality of augmented training examples.

At 308, the computing system trains a second query processing model to predict the first plurality of inferred labels for the first plurality of augmented training examples. In some implementations, training the second query processing model to predict the first plurality of inferred labels for the first plurality of augmented training examples comprises training the second query processing model to predict the first plurality of inferred labels based on the first plurality of queries exclusive of the one or more additional feature annotations. In some examples, the second query processing model has the same number of parameters as the first query processing model.

At 310, the computing system obtains a second plurality of unlabeled training examples, the second plurality of unlabeled training examples respectively comprising a second plurality of queries, each of the second plurality of unlabeled training examples comprising a smaller number of features than the first plurality of augmented training examples. In some implementations, the second plurality of unlabeled training examples is a larger number of training examples than the first plurality of unlabeled training examples.

At 312, the computing system processes the second plurality of unlabeled training examples with the second query processing model to respectively generate a second plurality of inferred labels for the second plurality of unlabeled training examples.

At 314, the computing system trains a third query processing model to predict the second plurality of inferred labels for the second plurality of unlabeled training examples. In some implementations, the third query processing model has a smaller number of parameters than the second query processing model.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for training query processing models, the method performed by one or more computing devices and comprising:
obtaining a first plurality of unlabeled training examples, the first plurality of unlabeled training examples respectively comprising a first plurality of queries;
augmenting the first plurality of queries with one or more additional feature annotations to generate a first plurality of augmented training examples;
processing the first plurality of augmented training examples with a first query processing model to respectively generate a first plurality of inferred labels for the first plurality of augmented training examples;
training a second query processing model to predict the first plurality of inferred labels for the first plurality of augmented training examples;
obtaining a second plurality of unlabeled training examples, the second plurality of unlabeled training examples respectively comprising a second plurality of queries, each of the second plurality of unlabeled training examples comprising a smaller number of features than the first plurality of augmented training examples;
processing the second plurality of unlabeled training examples with the second query processing model to respectively generate a second plurality of inferred labels for the second plurality of unlabeled training examples; and
training a third query processing model to predict the second plurality of inferred labels for the second plurality of unlabeled training examples.

2. The computer-implemented method of claim 1, wherein the first plurality of queries comprises queries of technical terminologies.

3. The computer-implemented method of claim 1, wherein the one or more additional feature annotations comprises URLs of documents retrieved for the first plurality of queries.

4. The computer-implemented method of claim 1, wherein the one or more additional feature annotations comprises titles of documents retrieved for the first plurality of queries.

5. The computer-implemented method of claim 1, wherein training the second query processing model to predict the first plurality of inferred labels for the first plurality of augmented training examples comprises training the second query processing model to predict the first plurality of inferred labels based on the first plurality of queries exclusive of the one or more additional feature annotations.

6. The computer-implemented method of claim 1, wherein the second query processing model comprises a same number of parameters as the first query processing model.

7. The computer-implemented method of claim 1, wherein the second plurality of unlabeled training examples comprises a larger number of training examples than the first plurality of unlabeled training examples.

8. The computer-implemented method of claim 1, wherein the third query processing model comprises a smaller number of parameters than the second query processing model.

9. The computer-implemented method of claim 1, further comprising obtaining a first plurality of labeled training examples, the first plurality of labeled training examples respectively comprising a first plurality of queries.

10. The computer-implemented method of claim 9, wherein the first plurality of labeled training examples are labeled with a query intent class.

11. A computing system for training query processing models, the computing system comprising:
one or more processors; and
one or more non-transitory computer-readable media that store instructions that, when executed by the one or more processors, cause the computing system to perform operations, the operations comprising:
obtaining a first plurality of unlabeled training examples, the first plurality of unlabeled training examples respectively comprising a first plurality of queries;
augmenting the first plurality of queries with one or more additional feature annotations to generate a first plurality of augmented training examples;
processing the first plurality of augmented training examples with a first query processing model to respectively generate a first plurality of inferred labels for the first plurality of augmented training examples;
training a second query processing model to predict the first plurality of inferred labels for the first plurality of augmented training examples;
obtaining a second plurality of unlabeled training examples, the second plurality of unlabeled training examples respectively comprising a second plurality of queries, each of the second plurality of unlabeled training examples comprising a smaller number of features than the first plurality of augmented training examples;
processing the second plurality of unlabeled training examples with the second query processing model to respectively generate a second plurality of inferred labels for the second plurality of unlabeled training examples; and
training a third query processing model to predict the second plurality of inferred labels for the second plurality of unlabeled training examples.

12. The computing system of claim 11, wherein the one or more additional feature annotations comprises URLs of documents retrieved for the first plurality of queries.

13. The computing system of claim 11, wherein the one or more additional feature annotations comprises titles of documents retrieved for the first plurality of queries.

14. The computing system of claim 11, wherein training the second query processing model to predict the first plurality of inferred labels for the first plurality of augmented training examples comprises training the second query processing model to predict the first plurality of inferred labels based on the first plurality of queries exclusive of the one or more additional feature annotations.

15. The computing system of claim 11, wherein the second query processing model comprises a same number of parameters as the first query processing model.

16. The computing system of claim 11, wherein the second plurality of unlabeled training examples comprises a larger number of training examples than the first plurality of unlabeled training examples.

17. The computing system of claim 11, wherein the third query processing model comprises a smaller number of parameters than the second query processing model.

18. The computing system of claim 11, wherein the operations further comprise obtaining a first plurality of labeled training examples, the first plurality of labeled training examples respectively comprising a first plurality of queries.

19. The computing system of claim 18, wherein the first plurality of labeled training examples are labeled with a query intent class.

20. One or more non-transitory computer-readable media that collectively store a third query processing model, wherein the third query processing model has been trained by performance of training operations, the training operations comprising:
obtaining a first plurality of unlabeled training examples, the first plurality of unlabeled training examples respectively comprising a first plurality of queries;
augmenting the first plurality of queries with one or more additional feature annotations to generate a first plurality of augmented training examples;
processing the first plurality of augmented training examples with a first query processing model to respectively generate a first plurality of inferred labels for the first plurality of augmented training examples;
training a second query processing model to predict the first plurality of inferred labels for the first plurality of augmented training examples;
obtaining a second plurality of unlabeled training examples, the second plurality of unlabeled training examples respectively comprising a second plurality of queries, each of the second plurality of unlabeled training examples comprising a smaller number of features than the first plurality of augmented training examples;
processing the second plurality of unlabeled training examples with the second query processing model to respectively generate a second plurality of inferred labels for the second plurality of unlabeled training examples; and
training the third query processing model to predict the second plurality of inferred labels for the second plurality of unlabeled training examples.
